(19) United States
(12) Patent Application Publication
(10) Pub. No.: US 2023/0036570 A1
(43) Pub. Date: Feb. 2, 2023

(54) SYSTEMS, APPARATUSES, AND METHODS FOR DECEPTIVE INFUSION OF DATA

(71) Applicants: Battelle Energy Alliance, LLC, Idaho Falls, ID (US); Purdue Research Foundation, West Lafayette, IN (US)

(72) Inventors: Ahmad Y. Al Rashdan, Salt Lake City, UT (US); Hany S. Abdel-Khalik, Idaho Falls, ID (US)

(21) Appl. No.: 17/815,876

(22) Filed: Jul. 28, 2022

Related U.S. Application Data
(60) Provisional application No. 63/227,389, filed on Jul. 30, 2021.

(51) Int. Cl. G06N 5/04

(52) U.S. Cl. CPC G06N 5/04

(57) ABSTRACT

Systems, apparatuses, and methods for deceptive infusion and obfuscation of data are disclosed. An apparatus including a communication terminal and a processing circuitry. The communication terminal is configured to transmit information to an artificial intelligence engine. The processing circuitry is configured to decompose raw data into fundamental metadata and inference metadata. The processing circuitry is also configured to generate one or more concealment operators and generate a deception kernel responsive to the inference metadata, the one or more concealment operators, and/or the fundamental metadata. The processing circuitry is configured to obfuscate the fundamental metadata responsive to the one or more concealment operators and the deception kernel, and provide the obfuscated fundamental metadata and the inference metadata to the artificial intelligence engine for processing.

### CROSS-REFERENCE TO RELATED APPLICATIONS

This application claims the benefit under 35 U.S.C. § 119(e) of U.S. Provisional Patent Application Ser. No. 63/227,389, filed Jul. 30, 2021, the disclosure of which is hereby incorporated herein in its entirety by this reference.

### STATEMENT REGARDING FEDERALLY SPONSORED RESEARCH OR DEVELOPMENT

This disclosure was made with government support under Contract Number DE-AC07-05-1D14517 awarded by the United States Department of Energy. The government has certain rights in the disclosure.

### TECHNICAL FIELD

Embodiments of the present disclosure relate generally to obfuscation of raw data before artificial intelligence or machine learning processing of the data.

### BACKGROUND

Owners of a proprietary system (e.g., scientific experiment or applied technology) may want to publicly disseminate findable, accessible, interoperable, and reusable (FAIR) scientific data to artificial intelligence/machine learning (AI/ML) researchers for processing. However, the data may contain sensitive or classified information that should not be publicly shared. Furthermore, even if the data is sanitized, the owners may be reluctant to share the information for fear that confidential information may be reverse engineered or compromised.

### BRIEF SUMMARY

Embodiments disclosed herein include methods, systems and/or apparatuses configured to obfuscate fundamental metadata for AI/ML processing. Some embodiments include an apparatus including a communication terminal configured to transmit information to an artificial intelligence engine. The apparatus may also include a processing circuitry configured to decompose raw data into fundamental metadata and inference metadata. The processing circuitry may be configured to generate one or more concealment operators and a deception kernel responsive to the inference metadata and the one or more concealment operators. The processing circuitry may be further configured to obfuscate the fundamental metadata responsive to the one or more concealment operators and the deception kernel. The processing circuitry may then be configured to provide the obfuscated fundamental metadata and the inference metadata to the artificial intelligence engine for processing.

Additional embodiments include a system including a deception engine configured to decompose raw data into fundamental metadata and inference metadata. The deception engine may be configured to generate one or more concealment operators and a deception kernel responsive to the inference metadata and the one or more concealment operators. The deception engine may also be configured to obfuscate the fundamental metadata responsive to the one or more concealment operators. The system may also include an artificial intelligence engine configured to receive data from the deception engine, the data comprising the obfuscated fundamental metadata and the inference metadata, process the received data, and provide the processed data to the deception engine.

Additional embodiments may be directed to a method including decomposing raw data into fundamental metadata and inference metadata. The method may further include generating one or more concealment operators and a deception kernel responsive to the inference metadata and the one or more concealment operators. The method also includes obfuscating the fundamental metadata responsive to the one or more concealment operators and the deception kernel, and providing the obfuscated fundamental metadata and the inference metadata to an artificial intelligence engine for processing.

### BRIEF DESCRIPTION OF THE DRAWINGS

FIG. 1 is a flowchart depicting a method for obfuscating fundamental metadata from benchmark raw data, according to some embodiments.

FIG. 2 is a block diagram depicting an apparatus for obfuscating and providing inference metadata to an artificial intelligence engine, according to one or more embodiments of the present disclosure.

FIG. 3 is a block diagram depicting a system for obfuscating and processing inference metadata, in accordance with one or more embodiments.

FIG. 4 is a flowchart depicting a method for operating a data processing network, according to one or more embodiments of the present disclosure.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, operations, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts may be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

It may be useful for analysts of a proprietary system (e.g., scientific experiment or applied technology) to extract findable, accessible, interoperable, and reusable (i.e., “FAIR”) scientific data for public dissemination and provide the data to artificial intelligence/machine learning (AI/ML) researchers in a manner that may not be reverse-engineered and/or may prevent disclosure of classified or proprietary information. Despite the benefits of designing publicly available and benchmarkable scientific datasets to optimally realize the value of AI/ML techniques, it may not be safe to release data, including sanitized data, about proprietary systems due to possible undesirable repercussions against the systems and/or system administrators, including losing support from the public or investors.

It may be desirable to develop, within a physical system (i.e., a system that behaves according to some governing laws), an AI/ML benchmark data preparation system capable of concealing the identity of the associated system while retaining all the functional dependencies desired to allow researchers to process the data and optimize AI/ML techniques. Differing from conventional privacy preserving, data masking, and anonymization techniques, the present disclosure relates to an efficient and time-space scalable methodology based on a non-invertible deceptive infusion of data (DIOD) methodology. The methodology may be designed to preserve correlations among benchmark datasets, representing the target information harvested by AI/ML techniques, while obfuscating a fundamental structure of the system's confidential underlying governing laws. This may be achieved in a non-invertible manner that may not be self-learned from the benchmark datasets. The present disclosure, including the disclosed DIOD methodology may represent a paradigm shift to data anonymity methods, such as k-anonymity, l-diversity, t-closeness, and m-invariance. Such data anonymity methods may focus on limiting access to structured datasets, such as, for example, personally identifiable information and health records. For protection of data, the conventional methods may either use non-discriminative loss of information or introduce ambiguity through means such as perturbation, encryption, or suppression that changes the inference characteristics of data and may impact the application of AI/ML techniques. The conventional methods provide limited protection because they do not impact the underlying governing structure. The obfuscation of data provenance may be compromised if enough data is provided through single or multiple data dissemination events. In contrast, various embodiments of the present disclosure focus on overcoming this limitation by obfuscating the underlying governing laws, without impacting the application of AI/ML methods. Various embodiments of the present disclosure expand the scope of data protection to scientific types of data, such as time-series data from critical experiments.

The DIOD methodology according to various embodiments of the present disclosure may use a non-unique AI/ML-invariant mathematical transformation for the disseminated data. The “invariance” property indicates that performance of AI/ML is not impacted by a transformation, whereas the “non-uniqueness” property means that any inference/inverse analysis attempting to estimate the transformation may not be successful. The present disclosure may include two or more operations including a decomposition operation and a fusion operation. In the decomposition operation, a randomized range finding algorithm may be used to decompose the benchmark multi-variate data into two sets of independent metadata. The first set is referred to as “fundamental metadata,” which describes the underlying governing laws, often represented by a combination of physics principles and constraints. As such, the fundamental metadata may be tied to an identity of the system that generated the benchmark datasets. The second set is denoted “inference metadata” and is used to train the AI/ML system. In the fusion operation, a mathematical kernel, employing a library of pre-calculated concealment operators, may be used to fuse the system-specific inference metadata with another set of fundamental metadata that are representative of a different system. The fusion operation allows preservation of the inference metadata, as is helpful for AI/ML training, while concealing the identity of the associated system to different levels of privacy, as is helpful for the owner of the data.

While the DIOD methodology according to various embodiments of the present disclosure is designed to protect the source data, its enabling algorithms may be based on reduced order modeling (ROM) techniques, which are adopted to reduce computational and storage requirements. These ROM techniques may enable efficient exchange of benchmark datasets and offer online application of the DIOD methodology at the data acquisition level. Further, this DIOD methodology may also enhance AI/ML research by emphasizing the concept of invariance in AI/ML learning, which is similar to the concept of physics law invariance. AI/ML learning may not be sub-optimally impacted by custom system knowledge, which is often embedded to constrain and guide the AI/ML learning.

Possible benefits of proprietary data dissemination to researchers may span multiple industries and topics. One non-limiting example of an application of various embodiments of the present disclosure may be in materials discovery, design, development, and deployment. Emerging materials may have a novel structure, designed with multi-functional properties to optimize performance for energy generation and storage, while simultaneously mitigating environmental impact. These stages in the material lifecycle have conventionally been treated largely as independent or weakly coupled. To effectively use AI/ML, data from all stages should be used, including high-fidelity modeling and simulation results, as well as process and performance parameters from manufacturing. Providing such detailed data for AI/ML processing may lead to reverse-engineering and identification of data provenance, which is a security/privacy concern for proprietary manufacturing data. The DIOD methodology according to various embodiments of the present disclosure may reduce or overcome this challenge and allow for data across all stages to be leveraged while masking the data provenance to a user-defined level of concealment.

In addition to becoming a new standard for FAIR-communication of proprietary scientific data to support advanced AI/ML learning, the various disclosed embodiments of DIOD methodology may open several new theoretical frontiers for the use of AI/ML techniques for the analysis of unique scientific data, whether experimentally-measured or simulated using high-fidelity modeling tools.

Research on the development and adoption of AI/ML techniques to improve the exploration and analysis of scientific systems has grown, in response to continued growth, complexity, and interconnectedness of systems, large volumes of collected data, and growth in computer processing power.

AI/ML techniques may achieve goals of improved data analysis via computationally efficient signature identification algorithms. These algorithms are capable of sifting through large volumes of data, i.e., recorded measurements and/or simulation data and extracting information that are relevant for AI/ML inference. These signatures are mathematical classifiers capable of differentiating between different system states and becoming state aware. For example, AI/ML techniques may accelerate materials discovery, design, development, and deployment, regardless of the application, as long as they are suited with a proper set of data.

The performance of AI/ML techniques should be carefully examined with techniques similar to model validation practices adopted in various fields. A key operation in any validation practice is the development of a benchmark model, which provides a common ground for researchers to test and compare methods. A conventional benchmark approach includes a clear description of the system and the subsystems layout, a comprehensive description of each subsystem model and associated design details, and a clear description of measurements and their uncertainties. While the adoption of this straightforward approach to test AI/ML techniques may be acceptable for a number of scenarios (e.g., design of new synthetic materials, imaging applications, feasibility of new simulation tools, etc.), this approach is unlikely to be adopted for high-valued classified or proprietary systems. A benchmark model for a high-valued system may allow for better system configurations that improve system function and resilience to various sources of uncertainties, representing the overarching goal of the application of AI/ML techniques. On the other hand, such benchmarks could be used to reverse engineer system information and functionality. This could potentially lead to identification of proprietary information and result in undesirable repercussions. Such undesirable identification may occur even if the benchmark model excludes key details from the released datasets. This is because AI/ML techniques are designed to identify patterns and association rules, and performance is greatly improved with knowledge of the governing laws, i.e., the “fundamental metadata” underlying system behavior as defined herein.

Therefore, proprietary and critical system details may be inferred from the released datasets, thus enabling malicious actors to gain access to protected information and an understanding of confidential functions. These concerns may discourage the owners of such systems from publicly disclosing any benchmark datasets even if heavily sanitized. An alternative method may be to hire private AI/ML resources, which may limit the benefits of the AI/ML validation procedure as compared to an approach that engages a wider research community. Thus, it may be helpful to develop AI/ML public benchmarks that may not be traced back to their associated systems. Depending on the level of identity masking desired, different levels of obfuscation strategies may be developed to hide various aspects of the associated original data identity. The DIOD methodology of the present disclosure is designed specifically to ensure optimal performance of AI/ML techniques for high-valued systems with masked data provenance.

Various embodiments of the disclosed DIOD methodology may include mathematical transformation of system benchmark datasets into a form that meets the following two-part criteria: (a) the benchmark data and their correlations may not be inverted, i.e., they may not be related back to the original system that generated the data; and (b) down to a preset tolerance, correlations (e.g., all of the correlations) in the original benchmark data may be rediscovered by AI/ML techniques in the DIOD benchmark data. These criteria allow researchers to devise strategies to test/validate AI/ML techniques without revealing the true identity of the system. The mathematical tools to enable such transformation rely on ideas from support vector machines, where instead of using simplified functions (e.g., radial basis functions, sigmoid functions, etc.), a template of pre-calculated known concealment operators, which is different from but may resemble the system's fundamental metadata, are employed to obfuscate a representation of the inference metadata extracted from the original system, i.e., decouple the inference metadata from their original fundamental metadata representation to a new representation. This may be done using rank-deficient transformations such that the deception process remains non-invertible, without impacting the inference metadata. In doing so, the AI/ML-relevant correlations existing between the raw (unmasked) data are preserved. Many of the decisions involved in the fusion operation, e.g., choice of the concealment operators, the kernel transformation, etc., are randomized using one-way hash functions such that the same raw (e.g., unmasked) benchmark data may be fused using different fundamental data corresponding to different systems. Thus, two groups of researchers may be given two different DIOD renditions of the same raw benchmark data.

Various embodiments of the disclosed DIOD methodology provide a generic theoretical framework for the testing of AI/ML techniques, reducing reliance on trial and error methods and customized AI/ML learning methods. By way of non-limiting example, in the healthcare field, knowledge extraction using data mining may be useful in classifying diseases and guiding physicians to optimize treatment strategies. Knowledge extraction may be achieved via a mathematical function, called a “classifier,” that is determined via an optimization-based training procedure against available data. Given that the training data contain private information such as patients' names, social security numbers, addresses, etc., which might be compromised due to attacks on enterprise computing systems, data anonymity (e.g., data obfuscation, data substitution, data masking, etc.) techniques may be useful to protect the private information. An objective of these techniques is to construct data mining models without violating the privacy of the data owners (i.e., the data mining model assumes no inference from the private data). In some instances, classifier accuracy is assumed to be insensitive to the private data. Conventional obfuscation techniques may include data alteration, perturbation, encryption, or suppression. These approaches may be effective when the private data, e.g., a patient's name or social security number, do not have an impact on the classifier function. In other situations, private data, such as sex or age, could have an impact on the classifier function. For such scenarios, encryption techniques may be employed, which may require decryption before application of the data mining model.

A goal of conventional privacy-preserving techniques may be to deny access to private data. In some instances it may be desirable to ensure access to relevant correlations (e.g., all the relevant correlations) and association rules inherent in datasets. This may be helpful to increase the potential of AI/ML techniques in identifying hidden and new patterns that may be leveraged to develop better insight and ultimately improve the associated system function and its resilience to uncertainties. Limiting access to some of the data may have a deteriorating impact on the quality of the AI/ML models, thus defeating the purpose of their application. As such, any alteration of the data should be done to reduce impact on the application of AI/ML techniques.

In conventional privacy-preserving data mining research, an impact of privacy on quality of data mining models may sometimes be characterized in terms of the model's “utility.” A high utility generally implies low privacy and vice versa. Conventional privacy-preserving methods like data perturbations and randomization treat privacy and utility as a pair of conflicting constraints, thus leading to an optimization approach to find, in a sense, an optimal trade-off solution that maximizes privacy while maintaining an acceptable level of utility. This approach is not adequate for some applications because all data relevant to AI/ML application should be made available. Removal of any data, e.g., certain process variables or data collected at certain conditions, may reduce the inference information available for AI/ML techniques leading to sub-optimal learning results. Various DIOD methodologies disclosed herein address this challenge by separating out, via a mathematical transformation, the benchmark datasets into two independent metadata sets—inference metadata, which is responsible for informing the AI/ML techniques, and fundamental metadata, which is tied to data provenance. Mathematically, AI/ML techniques are invariant to such decomposition.

Various DIOD methodology embodiments disclosed herein relate to the law of invariance observed in mathematical and theoretical physics, which is where an observed pattern is considered a governing law if it does not change due to some mathematical transformation.

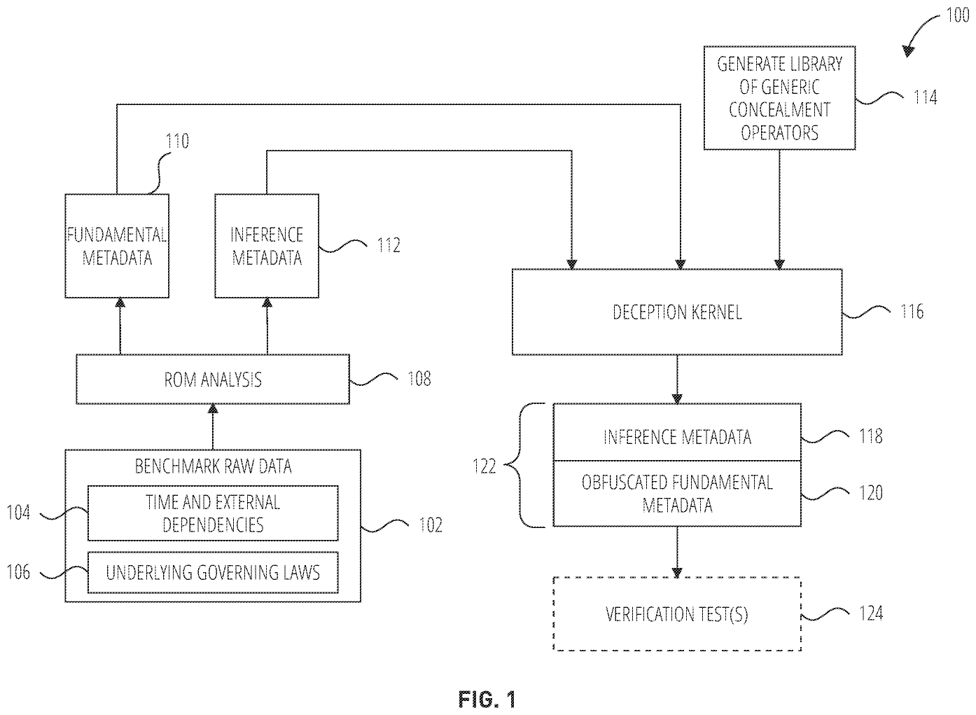

FIG. 1 is a flowchart depicting a method 100 for obfuscating fundamental metadata from benchmark raw data (e.g., a “DIOD methodology”), according to some embodiments.

In various embodiments disclosed herein, a DIOD methodology is related to the law of invariance observed in mathematical and theoretical physics. This law means that an observed pattern is considered a governing law if it does not change due to some mathematical transformation. In observing a system to discover its underlying inference metadata, the learned patterns should not be impacted by any processing of the observed data. AI/ML techniques should be rendered in an invariant manner. This has been realized in many areas, including, as non-limiting examples, handwritten text recognition, facial and object recognition, imaging, etc. Notable methods that may be rendered invariant include kNN (k Nearest Neighbors), kernelized methods, support vector machines, etc. Transformations may exist that do not impact performance of AI/ML techniques due to their invariance property, where the transformations are customized to meet user-defined concealment requirements.

Method 100 may include obtaining benchmark raw data 102. Benchmark raw data 102 may include dependencies such as time and external dependencies 104 and underlying fundamental governing laws 106. The benchmark raw data 102 may be decomposed into fundamental metadata 110 (e.g., metadata representing the underlying fundamental governing laws 106) and inference metadata 112 (e.g., metadata representing anything that is not fundamental, including, for example, time and external dependencies 104). In some embodiments, the decomposition may be performed via a reduced order modeling (ROM) analysis technique 108. ROM analysis 108 may be an efficient mathematical construct capable of capturing the dominant features of system dynamics related to the benchmark raw data 102. In some embodiments, the ROM analysis 108 may describe system variables y variations using a decomposable expression of the form:

y(x,α)≅Σᵢ₌₁ωᵢ(α)φᵢ(x)

where x denotes position in the phase space (e.g., space and time) and a denotes a set of control variables that specify the conditions under which the system is being observed, e.g., experimental conditions, forcing functions, boundary and initial conditions, etc. The r functions form a basis for an active subspace, which approximates possible variations for the system variables within a user-defined tolerance such that:

|y(x,α)−Σᵢ₌₁^{r}ωᵢ(α)φᵢ(x)|<ϵ

Active subspace functions may be captured (e.g., through some form of optimization) using randomized range finding algorithms. These functions are related to the underlying laws governing system behavior and its design specifications, including geometry details, compositions, and system proprietary information. The weights ωᵢ(α) may be influenced by control variables. Patterns in the system variables may be split into two sets of metadata. The first metadata (e.g., fundamental metadata 110, represented by ϕ) are determined by the underlying behavior operator and system configurations. By way of non-limiting example, fundamental metadata 110 may include proprietary information such as the geometry of the system, material composition, underlying differential equations, etc., that may disclose the identity of the system. The second metadata (e.g., inference metadata 112, represented by co) are determined by the system operational conditions. By way of non-limiting example, inference metadata 112 may include information about the operational history of the system such as the temperature, mass flow rate, and other control parameters that are relevant to the AI/ML applications for optimization or inference purposes. The fundamental metadata 110 may be provided as input to the AI/ML techniques to help guide the optimal identification of the inference metadata 112. Metadata may be data that are derived from the raw data in support of identifying data provenance and enabling AI/ML-based inference.

The method 100 may include generating a library of generic concealment operators, as shown in operation 114. This operation 114 may be performed one time and may be focused on preparation of a pre-calculated library of operators that may be used to conceal the identity of the original system. This library may be generated seamlessly by applying a similar ROM decomposition as described above to multiple standard test problem data from a variety of disciplines. The library may be developed to achieve two or more different levels of concealment. A first level may focus on building a benchmark model that represents a given class of systems (e.g., class of materials with desired general properties for a given application). The true identity of the concealed system within the class is to remain unidentifiable. A second masking level may be designed for adversarial scenarios where the true identity of the system is concealed and its class remains unidentifiable. The first masking level may be valuable to a wide range of science fields (e.g., materials, fusion, energy cells, etc.) interested in developing generic AI/ML techniques to improve performance across a scientific field, to be done in a manner that does not reveal the original data provenance. The second masking level may target highly critical or classified applications. The concealment operators generated in operation 114 may have some resemblance to the system benchmark raw data 102, or may be selected to be completely independent.

The method 100 may combine (e.g., fuse) the decomposed metadata (e.g., fundamental metadata 110 and/or inference metadata 112) and the generated concealment operators using a deception kernel 116 to generate DIOD benchmark data 122, which hides the identity of the system and its associated governing laws. The DIOD benchmark data 122 may include inference metadata 118 and obfuscated fundamental metadata 120. In one or more embodiments, the inference metadata 118 is identical to the inference metadata 112, or may be functionally equivalent to inference metadata 112. In some embodiments, the deception kernel 116 may be represented by the following:

k(x,x′)=Σᵢ₌₁^{r}ψᵢ(x′)φ*ᵢ(x).

The superscripted * denotes inner product operation when the kernel is applied to a given function. This kernel is designed to take a given realization of the variables y(x,a) and generate its DIOD version, denoted by the primed variables, such that

y′(x′,α)≅∫k(x′,x)y(x,α)dx,

where the functions ψᵢ(x) represent a member of the concealment operators generated at operation 114. The deception kernel is a transformation that effectively “overwrites” the fundamental metadata of the proprietary system with that of the generic system, thus masking the proprietary information. As explained earlier, DIOD benchmarks may completely obfuscate the identity of the system or may retain some features about the system or the data provenance depending on the ultimate goal of the benchmark application. When no obfuscation is desired, the following functions are set to be equal to each other: ψᵢ(x)=ϕᵢ(x). If the functions ψᵢ(x′) are selected to be orthonormal, the DIOD data may be decomposed into:

y′(x′,α)≅Σᵢ₌₁^{r}ωᵢ(α)ψᵢ(x′).

This equation means that an AI/ML application to the original and DIOD data would yield the same inference metadata ωᵢ(α) (e.g., inference metadata 112). With invariant AI/ML techniques, additional rotation and scaling type transformation P may be introduced to further obfuscate the inference data as follows:

y′(x′,α)≅Σᵢ₌₁^{r}[Pωᵢ(α)]ψᵢ(x′).

The DIOD kernel allows the space x′ to be generally different from the original benchmark space x. Depending on the sought level of concealment, the two spaces may be the same.

In one or more embodiments, an optional operation of method 100 is verification test(s) 124, which tests the performance of the DIOD benchmark data 122. Verification tests may be designed using representative datasets from a scientific testing experiment. The selected datasets may be used to determine whether the AI/ML-based classifiers have the same classification accuracy, as calculated in terms of the false positives and the decision boundaries for the classifiers against the projected performance using the benchmark raw (i.e., unmasked) data.

The verification tests 124 may be designed to represent a broad spectrum of systems behavior and incorporate various cyclic and spares patterns. A standard class of AI/ML-based classifiers may be selected for designing the test cases, e.g., support vector machines, kNN, neural networks, Lasso regression, long short-term memory neural networks for time-based regression, principal component analysis and a kernelized version. Distance measure (e.g., Euclidean, Manhattan, Chebyshev, and Mahalanobis, etc.) may be used for testing the performance of the raw benchmark data.

The robustness of the fundamentals-decomposition methodology from the ROM analysis 108 may be tested against various sources of uncertainties in the DIOD benchmark data. AI/ML techniques may be subject to instability (e.g., due to noise in the training data) that may lead to unpredictable and erroneous classification results. Thus, robustness tests may be designed for insensitivity of the decomposition algorithm to the various sources of uncertainties resulting from the raw benchmark data. Invariance of the distance measures to the DIOD transformation may be assessed, since they represent the basis for the majority of AI/ML-based classifiers. Mathematically, the deception kernel 116 K may be designed such that, for a given classifier f, the following identity holds:

f_{Ky}(Kz)=f_{y}(z),

where y is the original benchmark data used to train a classifier f, and f_{y}(z) are the results of the classification as applied to test data z. This equation implies that the same classifier trained on the transformed data, Ky, should give the same classification accuracy when applied to test transformed test data z. The disclosed deception kernel 116 is designed to satisfy this criterion. This is because, for example, using a kNN classifier, the class of a point is determined by the class of the nearby points. If the distance measure employed is invariant to transformation, the same classification may be rendered. The same conclusion applies to other kernelized methods, including support vector machines, which rely on distance measures and may be invariant to transformation.

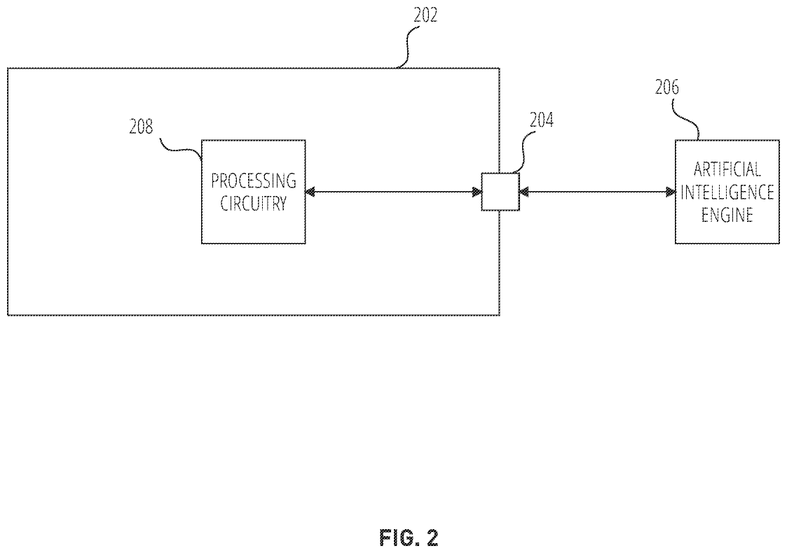

FIG. 2 is a block diagram depicting an apparatus 202 for obfuscating and providing inference metadata to an artificial intelligence engine 206 according to one or more embodiments of the present disclosure. The apparatus 202 may include a processing circuitry 208 and a communication terminal 204. Several functions of the processing circuitry 208 are discussed in more detail with reference to FIG. 1. For example, the processing circuitry 208 may perform the ROM analysis 108, perform the operation 114 of generating the library of concealment operators, and may fuse the concealment operators, the fundamental metadata 110, and the inference metadata 112 using the deception kernel 116.

The processing circuitry 208 may decompose raw data into fundamental metadata and inference metadata. In some embodiments, the processing circuitry 208 may decompose the raw data by passing the raw data through a reduced order model. The processing circuitry 208 may generate one or more concealment operators. The processing circuitry 208 may generate a deception kernel responsive to the inference metadata and the one or more concealment operators generated by the processing circuitry 208. In one or more embodiments, the processing circuitry 208 may generate the deception kernel responsive to the inference metadata, the one or more concealment operators, and the fundamental metadata. The processing circuitry may obfuscate (i.e., mask, conceal, hide, blind, etc.) the fundamental metadata responsive to the one or more concealment operators and the deception kernel. In some embodiments, the deception kernel is configured to replace the fundamental metadata with the generated concealment operators. In one or more embodiments, the fundamental metadata is fused with the concealment operators to obfuscate the fundamental metadata responsive to the deception kernel. The processing circuitry may provide the obfuscated fundamental metadata and the inference metadata to the artificial intelligence engine 206 via the communication terminal 204. The communication terminal 204 may transmit information to any outside destination, including public destinations for data sharing.

The artificial intelligence engine 206 may process the obfuscated fundamental metadata to extract trends, determine patterns, predict future outcomes, etc. In some embodiments, results and solutions determined from the processed information may be transmitted to the apparatus 202. In such cases, the communication terminal 204 may be configured to receive the information and provide the results, solutions, and/or processed information to the processing circuitry 208.

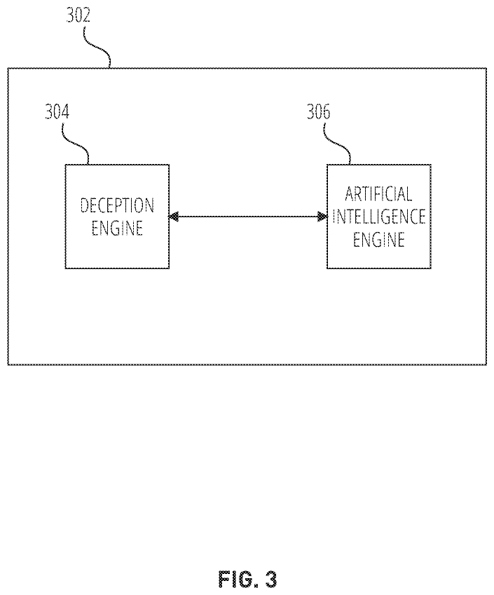

FIG. 3 is a block diagram depicting a system 302 for obfuscating and processing inference metadata, in accordance with one or more embodiments. The system 302 may include a deception engine 304 and an artificial intelligence engine 306. The deception engine 304 may be an example of an apparatus 202 of FIG. 2. The artificial intelligence engine 306 may be an example of an artificial intelligence engine 206 of FIG. 2.

The deception engine 304 may decompose raw data into fundamental metadata and inference metadata. The deception engine 304 may generate one or more concealment operators. The deception engine 304 may further generate a deception kernel responsive to the inference metadata and the one or more concealment operators. The deception engine may obfuscate the fundamental metadata responsive to the one or more concealment operators and the deception kernel, and may provide the obfuscated metadata to the artificial intelligence engine 306.

The artificial intelligence engine 306 may receive the obfuscated fundamental metadata and the inference metadata from the deception engine 304 for processing. The artificial intelligence engine 306 may process the received data and provide the resulting solutions and/or processed data to the deception engine.

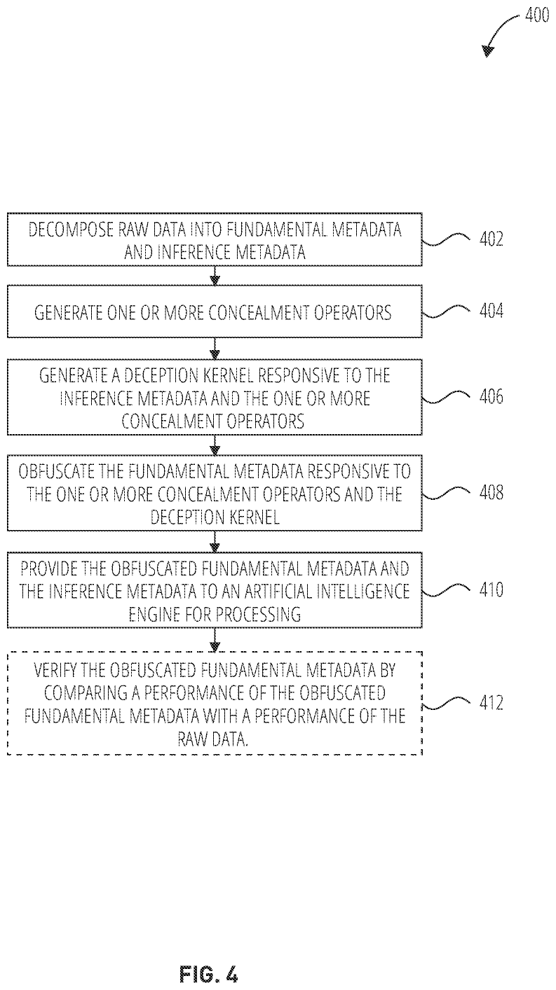

FIG. 4 is a flowchart depicting a method 400 for operating a data processing network, according to one or more embodiments of the present disclosure. In operation 402, method 400 decomposes raw data into fundamental metadata (e.g., fundamental metadata 110 of FIG. 1) and inference metadata (inference metadata 112 of FIG. 1). ROM analysis 108 of FIG. 1 may be an example of operation 402. In operation 404, method 400 generates one or more concealment operators. Operation 114 of FIG. 1 may be an example of operation 404. In one or more embodiments, method 400 may generate one or more concealment operators by decomposing a second set of raw data. In some cases, the second set of raw data may be related to the raw data and in other cases, the second set of raw data may be unrelated to the raw data. In operation 406, method 400 generates a deception kernel responsive to the inference metadata and the one or more concealment operators. The deception kernel 116 of FIG. 1 may be an example of the deception kernel that is generated in operation 406. In operation 408, method 400 obfuscates the fundamental metadata responsive to the one or more concealment operators and the deception kernel. In operation 410, method 400 provides the obfuscated fundamental metadata and the inference metadata to an artificial intelligence engine for processing. In optional operation 412, method 400 may verify the obfuscated fundamental metadata by comparing a performance of the obfuscated fundamental metadata with a performance of the raw data.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, without limitation) of the computing system. In some embodiments, the different components, modules, engines, and services described in the present disclosure may be implemented as objects or processes that execute on the computing system (e.g., as separate threads). While some of the devices, systems, and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to some embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated some embodiments, those of ordinary skill in the art will recognize and appreciate that the present disclosure is not so limited. Rather, many additions, deletions, and modifications to the illustrated and described some embodiments may be made without departing from the scope of the disclosure as hereinafter claimed along with their legal equivalents. In addition, features from one some embodiment may be combined with features of another some embodiment while still being encompassed within the scope of the disclosure as contemplated by the applicant.

What is claimed is:

1. An apparatus, comprising:
a communication terminal configured to transmit information to an artificial intelligence engine; and
a processing circuitry configured to:
decompose raw data into fundamental metadata and inference metadata;
generate one or more concealment operators;
generate a deception kernel responsive to the inference metadata and the one or more concealment operators;
obfuscate the fundamental metadata responsive to the one or more concealment operators and the deception kernel; and
provide the obfuscated fundamental metadata and the inference metadata to the artificial intelligence engine for processing.

2. The apparatus of claim 1, wherein the processing circuitry is configured to generate the deception kernel responsive to the inference metadata, the one or more concealment operators, and the fundamental metadata.

3. The apparatus of claim 2, wherein the processing circuitry is configured to obfuscate the fundamental metadata by fusing the concealment operators and the fundamental metadata together.

4. The apparatus of claim 1, wherein the processing circuitry is configured to obfuscate the fundamental metadata by replacing the fundamental metadata with the concealment operators.

5. The apparatus of claim 1, wherein the processing circuitry is configured to decompose the raw data into the fundamental metadata and the inference metadata by passing the raw data through a reduced order model.

6. The apparatus of claim 1, wherein the communication terminal is configured to receive information from the artificial intelligence engine.

7. The apparatus of claim 1, wherein the processing circuitry is configured to generate one or more concealment operators by decomposing a second set of raw data.

8. The apparatus of claim 1, wherein the processing circuitry is configured to generate at least two sets of concealment operators, where a first set of concealment operators has a first security level and a second set of concealment operators has a second security level.

9. The apparatus of claim 1, wherein the processing circuitry is configured to:
generate the one or more concealment operators responsive to first one-way hash functions; and
generate the deception kernel responsive to second one-way hash functions.

10. The apparatus of claim 1, wherein the fundamental metadata represents underlying governing laws related to a system described by the raw data.

11. The apparatus of claim 1, wherein the inference metadata represents data used to train the artificial intelligence engine.

12. A system, comprising:
a deception engine configured to:
decompose raw data into fundamental metadata and inference metadata;
generate one or more concealment operators;
generate a deception kernel responsive to the inference metadata and the one or more concealment operators; and
obfuscate the fundamental metadata responsive to the one or more concealment operators and the deception kernel; and
an artificial intelligence engine configured to:
receive data from the deception engine, the data comprising the obfuscated fundamental metadata and the inference metadata;
process the received data; and
provide the processed received data or an artificial intelligence method responsive to the processed received data to the deception engine.

13. The system of claim 12, wherein the deception engine is configured to provide the obfuscated fundamental metadata and the inference metadata to the artificial intelligence engine.

14. The system of claim 12, wherein the deception engine is configured to generate the deception kernel responsive to the inference metadata, the one or more concealment operators, and the fundamental metadata.

15. The system of claim 12, wherein the artificial intelligence engine is configured to process the inference metadata of the received data.

16. The system of claim 12, wherein the deception engine is configured to compare a performance of the raw data to a performance of the processed data received from the artificial intelligence engine.

17. A method, comprising:
decomposing raw data into fundamental metadata and inference metadata;
generating one or more concealment operators;
generating a deception kernel responsive to the inference metadata and the one or more concealment operators;
obfuscating the fundamental metadata responsive to the one or more concealment operators and the deception kernel; and
providing the obfuscated fundamental metadata and the inference metadata to an artificial intelligence engine for processing.

18. The method of claim 17, wherein decomposing the raw data into the fundamental metadata and the inference metadata comprises passing the raw data through a reduced order model.

19. The method of claim 17, further comprising verifying the obfuscated fundamental metadata by comparing a performance of the obfuscated fundamental metadata with a performance of the raw data.

20. The method of claim 17, wherein generating the one or more concealment operators comprises decomposing a second set of raw data.
